(19) United States
(12) Patent Application Publication
(10) Pub. No.: US 2005/0190977 A1
(43) Pub. Date: Sep. 1, 2005

(54) Method and apparatus for video encoding

(75) Inventors: Byeung-woo Jeon, Gyeonggi-do (KR); Je-yun Lee, Metropolitan City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/999,915

(22) Filed: Dec. 1, 2004

Related U.S. Application Data
(60) Provisional application No. 60/526,130, filed on Dec. 2, 2003.

(30) Foreign Application Priority Data
Feb. 2, 2004 (KR) 2004-6651

(51) Int. Cl. G06K 9/36; G06K 9/46

(52) U.S. Cl. 382/239; 382/236

(57) ABSTRACT

Provided are a method and apparatus for video encoding, in which an encoding mode is rapidly decided and video encoding is performed in the decided encoding mode. The method for video encoding includes determining whether a predetermined block of a predetermined size forming a video satisfies predetermined conditions corresponding to a first mode that is included in a plurality of encoding modes used to encode the video and choosing the first mode as an encoding mode of the predetermined block if the predetermined conditions are satisfied.

### CROSS REFERENCE TO RELATED APPLICATION

This application claims the priority of Korean Patent Application No. 2004-6651, filed on Feb. 2, 2004, in the Korean Intellectual Property Office, and U.S. Provisional Patent Application No. 60/526,130 filed on Dec. 2, 2003, in the United States Patent and Trademark Office, the disclosures of which are incorporated herein in its entirety by reference.

### BACKGROUND OF THE INVENTION

1. Field of the Invention

Methods and apparatuses consistent with the present invention relate to video encoding, and more particularly, to video encoding in which an encoding mode is rapidly decided in video encoding and video encoding is performed in the decided encoding mode.

2. Description of the Related Art

To carry out video encoding in accordance with the H.264 standard, which concerns video compression, one picture is divided into macroblocks. After each of the macroblocks is encoded in all the encoding modes for inter prediction and in all the encoding modes for intra prediction, an encoding mode is decided based on a bit rate required for encoding of the macroblocks and the degree of distortion between the original macroblocks and the encoded macroblocks and video encoding is performed in the decided encoding mode.

Inter mode is used in inter prediction, which is directed to encoding differences between motion vector information and pixel values for the purpose of encoding macroblocks of a current picture, in which the motion vector information indicates the position of one block or positions of a plurality of blocks, as decided with respect to a reference picture. Since a maximum of 5 reference pictures at any particular time can be obtained in accordance with H.264, blocks to which current macroblocks are to refer to are searched for by investigating reference pictures in a frame memory that stores the reference pictures. The reference pictures stored in the frame memory may be past pictures or future pictures with respect to the current pictures.

Intra mode is used in intra prediction, which is directed to calculating predicted pixel values of macroblocks to be encoded using pixel values spatially adjacent to the macroblocks to be encoded, instead of referring to reference pictures, and then encoding differences between the predicted pixel values and the pixel values for the purpose of encoding macroblocks of the current picture.

However, there exist a large number of inter modes in the inter prediction corresponding to the various ways in which the macroblocks are divided and in the intra mode corresponding to various prediction directions. Thus, determining the optimal mode from among all the modes is important to video encoding performance. To this end, rate-distortion costs (RDcosts) for all the possible modes are generally calculated and a mode having the smallest rate-distortion cost is decided as the optimal encoding mode. However, such a process requires much time and money for video encoding.

### SUMMARY OF THE INVENTION

The present invention provides a method and apparatus for video encoding, in which an encoding mode is rapidly decided by performing an encoding mode decision according to a predetermined order and video encoding is performed in the decided encoding mode.

In an embodiment, the present invention provides a method for video encoding including: (a) determining whether a predetermined block of a predetermined size forming a video satisfies predetermined conditions corresponding to a first mode of a plurality of video encoding modes; and (b) choosing the first mode as an encoding mode of the predetermined block if the predetermined conditions are satisfied.

In another embodiment, the present invention provides a method for video encoding comprising: (a) calculating temporal similarity of a predetermined block of a predetermined size forming a video with a reference block of a reference picture in an inter mode; and (b) determining whether to omit an encoding process in an intra mode according to the calculated temporal similarity and spatial similarity between a block of the current picture and an adjacent block.

In other embodiments, the present invention provides an apparatus for video encoding as described above.

In addition, the present invention provides for a computer readable medium having embodied thereon programs for implementing a method for video encoding as described above.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram of an apparatus for video encoding according to an embodiment of the present invention;

FIG. 2 illustrates various ways of dividing macroblocks in inter prediction;

FIG. 3 illustrates an example in which various block types are assigned to each macroblock of a current picture to be encoded;

FIG. 4 illustrates a luminance block P to be predicted and adjacent blocks used in prediction;

FIGS. 5A and 5B are views for explaining calculation of predicted motion vectors (PMVs);

FIG. 6 is a view for explaining calculation of RDcosts;

FIG. 7 is a flowchart illustrating a method of deciding an encoding mode;

FIG. 8A and 8B are views for explaining calculation of average boundary errors (ABEs);

FIG. 9 is a schematic block diagram of an apparatus for video encoding according to an embodiment of the present invention; and

FIG. 10 is a schematic block diagram of an apparatus for video encoding according to another embodiment of the present invention.

### DETAILED DESCRIPTION OF THE INVENTION

The present invention will now be described more fully with reference to the accompanying drawings.

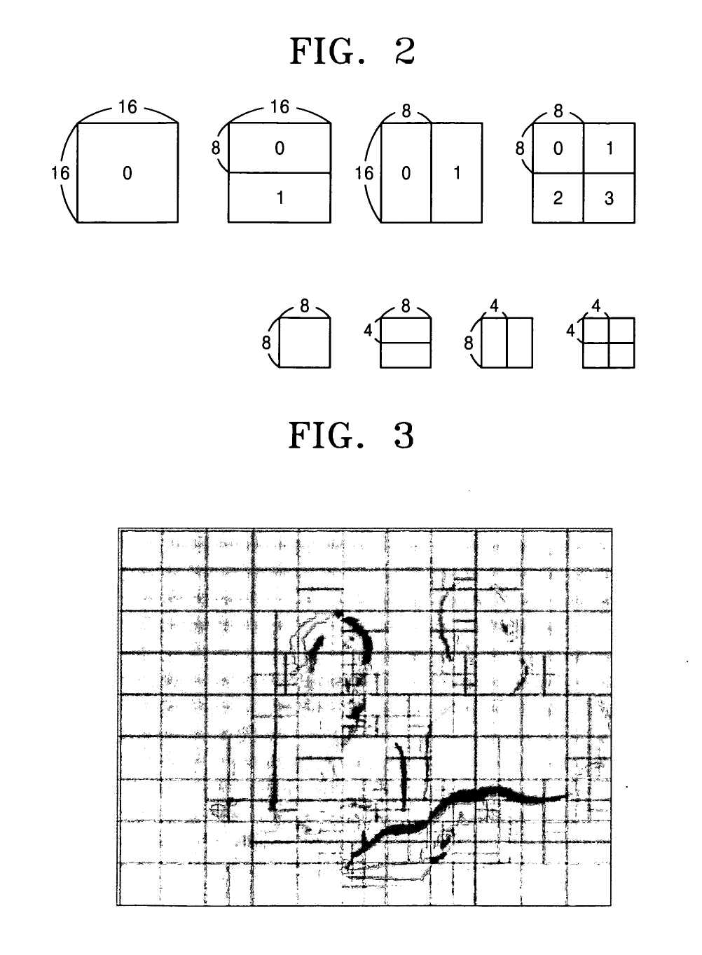

An apparatus for video encoding according to the present invention encodes video data. The video data is composed of a plurality of pictures arranged along a time axis and each picture is composed of a plurality of blocks. The blocks include macroblocks and subblocks that are obtained by halving or quartering the macroblocks in a vertical or horizontal direction. Division of the macroblocks will be described later with reference to FIG. 2.

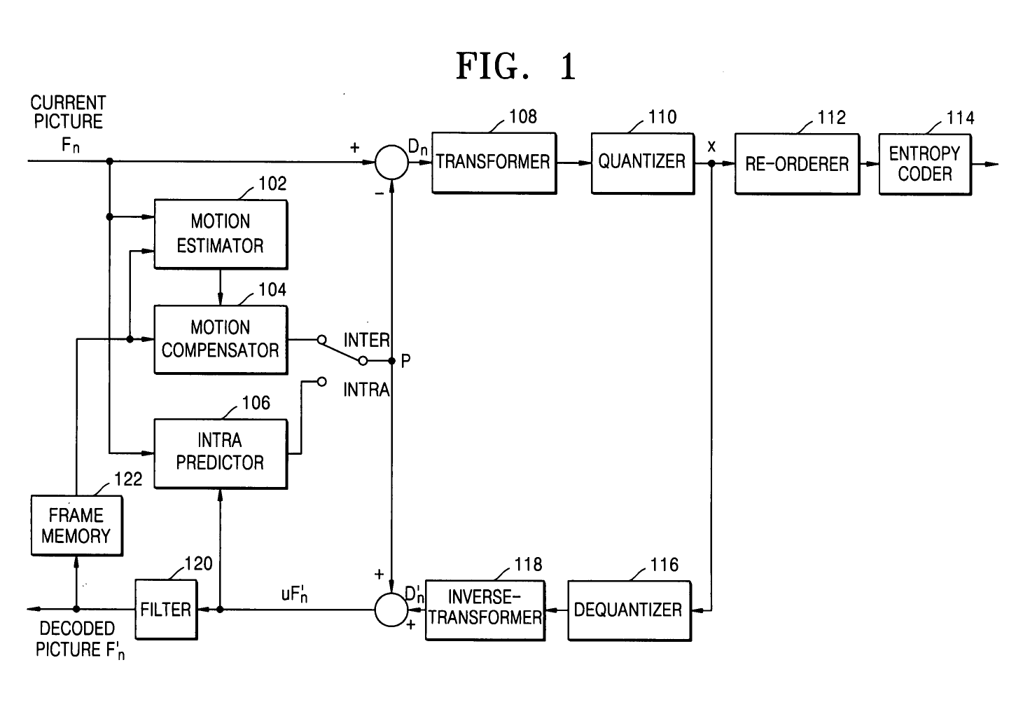

FIG. 1 is a block diagram of an apparatus for video encoding according to an embodiment of the present invention.

The apparatus for video encoding includes a motion estimator 102, a motion compensator 104, an intra predictor 106, a transformer 108, a quantizer 110, a re-orderer 112, an entropy coder 114, a dequantizer 116, an inverse transformer 118, a filter 120, and a frame memory 122.

The apparatus for video encoding performs encoding with respect to macroblocks of a current picture in an encoding mode chosen from among various encoding modes. To this end, RDcosts are calculated by performing encoding in all the possible modes inter prediction and intra prediction can have, a mode having the smallest RDcost is chosen as the optimal encoding mode, and encoding is performed in the chosen encoding mode. The RDcost will be described in detail later. However, in a method of choosing an encoding mode of the present invention, choosing the optimal encoding mode is not necessarily performed by means of calculation of RDcosts and may be performed using a variety of different methods.

The motion estimator 102 searches in a reference picture for inter prediction for predicted values of macroblocks of a current picture. If reference blocks are found in half pixel units or quarter pixel units, the motion compensator 104 chooses reference block data values using the found half pixels and quarter pixels. As such, inter prediction is performed by the motion estimator 102 and the motion compensator 104.

Also, the intra predictor 106 performs intra prediction directed to searching for the predicted values of the macroblocks of the current picture from the current picture. Whether to perform inter prediction or intra prediction for the current macroblocks is determined by RD costs in all the encoding modes. After calculating the RDcosts in all the encoding modes, choosing a mode having the smallest RDcost as the encoding mode for the current macroblocks, and performing encoding of the current macroblocks.

As described above, once prediction data to which macroblocks of a current frame are to refer to is found by performing inter prediction or intra prediction, the predicted data is subtracted from the macroblocks of the current frame, transform is performed in the transformer 108, and quantization is performed in the quantizer 110. Results of subtracting motion estimated reference blocks from the macroblocks of the current frame are referred to as residual signals and the residual signals are encoded to reduce the amount of data in encoding. The quantized residual signals are reordered by the re-orderer 112 and then encoded by the entropy coder 114.

To obtain a reference picture to be used in inter prediction, a quantized picture is dequantized by the dequantizer 116 and then processed by the inverse transformer 118, and thus the current picture is decoded. The decoded current picture is stored in the frame memory 122 and used to perform inter prediction on the next picture. Once the decoded picture passes through the filter 120, it is converted to a picture including some encoding errors in addition to those of the original picture.

FIG. 2 illustrates various ways of dividing macroblocks in inter prediction.

In inter prediction according to H.264, one 16×16 macroblock can be divided into 16×16, 16×8, 8×16, or 8×8 subblocks and each 8×8 block can be divided into 8×4, 4×8, or 4×4 subblocks. Motion estimation and compensation are performed on these subblocks, thereby motion vectors are determined for each subblock. If inter prediction is performed in various block modes, encoding can be effectively performed with respect to the characteristics and movement of object in a video.

FIG. 3 illustrates an example in which various block types are assigned to each of the macroblocks of the current picture to be encoded.

Referring to FIG. 3, the sizes of the variable blocks are assigned such that inter prediction is performed using a large block when motion of a video is simple and an object is large and using a small block when motion of a video is complex and an object is small.

Therefore, one macroblock can have various kinds of subblocks. As described above, since one macroblock is divided into 16×8, 8×16, or 8×8 blocks and each 8×8 block is divided into 8×4, 4×8, or 4×4 blocks, the kind of modes one macroblock can have includes four kinds of 16×16, 16×8, 8×16, and 8×8 and four kinds of block belong to each 8×8 block. Therefore, a total of 4+(4×4×4×4−1)=259 kinds of mode for each macroblock exist. Therefore, in inter prediction, one mode is chosen after RDcosts for 259 kinds of mode are calculated, resulting in a large amount of calculation.

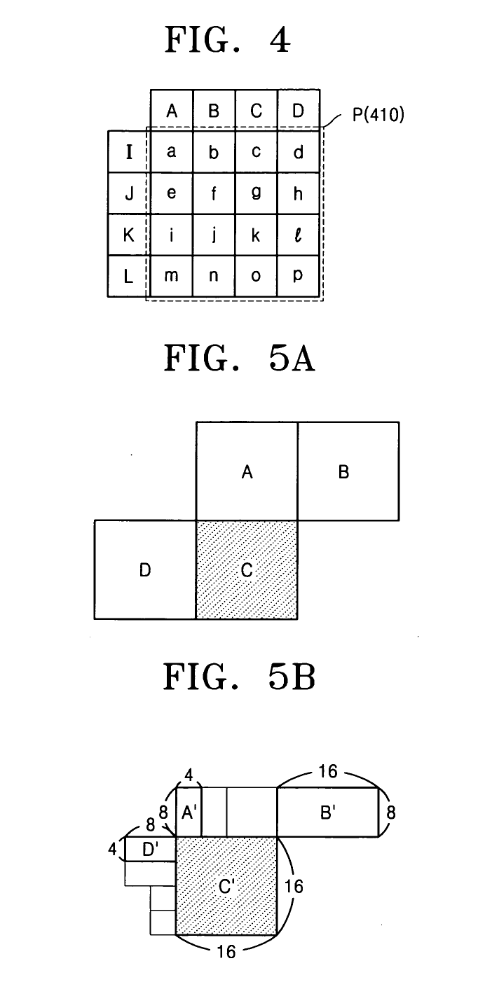

FIG. 4 illustrates a luminance block P to be predicted and adjacent blocks to be used in prediction.

Intra prediction is performed with respect to luminance and chrominance. Once a block is encoded in the intra mode, a block P 410 to be predicted is predicted using decoded blocks A through L adjacent to the block P 410. Prediction is performed on not only luminance (luma) blocks but also chrominance (U and V signals) blocks. The luminance block P 410 is a 16×16 block composed of several 4×4 blocks. Here, blocks a through p are 4×4 blocks to be predicted and A, B, C, D and I, J, K, L are blocks used in prediction.

Intra prediction can be classified into two types according to the size of a block to be predicted: 4×4 prediction and 16×16 prediction. Also, according to a prediction direction, there are 9 modes in 4×4 prediction and there are 4 modes in 16×16 prediction. The 9 modes in 4×4 prediction are classified according to prediction directions in which prediction samples are obtained using pixel values of the blocks A, B, C, D and I, J, K, L adjacent to a 4×4 block to be predicted.

More specifically, a 4×4 intra luma prediction mode includes a vertical mode, a horizontal mode, a DC mode, a diagonal_down_left mode, a diagonal_down_right mode, a vertical_right mode, a horizontal_down mode, a vertical_up mode, and a horizontal_up mode. A 16×16 intra luma prediction mode includes a vertical mode, a horizontal mode, a DC mode, and a plane mode. Since RDcosts should be calculated in various modes such as the above modes, a large amount of calculation is required like in inter prediction.

FIGS. 5A and 5B are views for explaining calculation of PMVs.

Referring to FIG. 5A, a motion vector of a current macroblock C has a high probability of being similar to those of adjacent macroblocks. Thus, the motion vector of the current macroblock C is predicted using the motion vectors of adjacent macroblocks A, B, and D. Prediction may be performed by calculating a median value of the motion vectors of the macroblocks A, B, and D. In encoding, the PMVs are subtracted from actual motion vectors.

As shown in FIG. 5B, if the size of the current block C is different from that of a divided block of an adjacent macroblock, there exists a problem of choosing an adjacent block from among divided blocks of the adjacent macroblocks. At this time, a block A′ at the very left of adjacent blocks above the current block, a block B′ diagonally adjacent in the upper right direction to the topmost and rightmost pixel of the current block, and a block D′ at the highest level among blocks adjacent to the left side of the current block are selected. The PMVs are calculated using motion vectors of the selected blocks A′, B′, and D′.

In H.264 encoding, prediction is performed by selecting a mode chosen during inter prediction or a mode chosen during intra prediction. Compression efficiency of H.264 depends on a chosen mode in which prediction is performed. To select the best mode, prediction of a block is performed using all the modes and RDcosts are calculated.

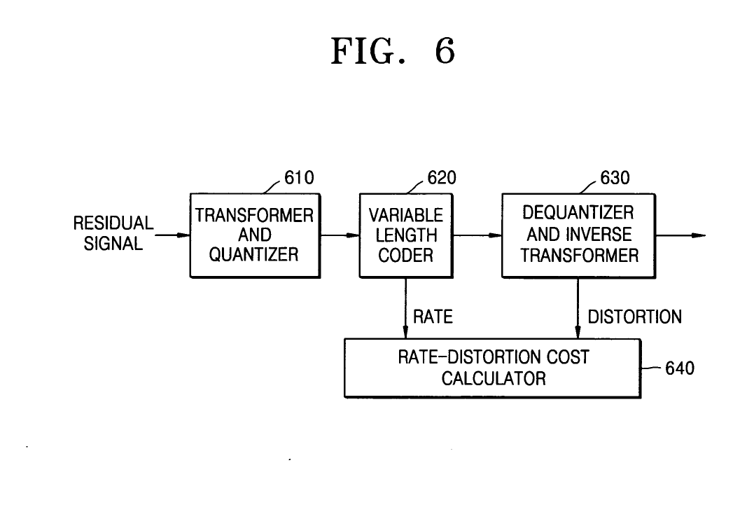

FIG. 6 is a view for explaining calculation of RDcosts.

A rate R means a bit rate and indicates the number of bits used in encoding one macroblock. Thus, the rate R is the sum of the number of bits obtained by processing residual signals left after inter prediction or intra prediction in a transformer and quantizer 610 and a variable length coder 620, the number of bits obtained by processing motion vector information in the variable length coder 620, and the number of bits obtained by processing reference picture information in the variable length coder 620. In contrast, a distortion D indicates a difference between the original macroblock and a decoded macroblock when an encoded video is decoded. Thus, the distortion D can be obtained once the original macroblock is decoded after being processed by a dequantizer and inverse-transformer 630. The RDcost is calculated by a rate-distortion cost calculator 640 using the obtained rate and distortion as follows.
RDcost=Distortion+λ×Rate (1),
where Distortion indicates a difference in pixel value between the current macroblock and a corresponding macroblock that is encoded, and then decoded, and is calculated using Equation 2. Rate indicates a bit rate calculated using a method as described above.

$$Distortion = {\sum }_{k = 0}^{15} {\sum }_{l = 0}^{15} {( B ( k , l ) - {B}^{′} ( k , l ) )}^{2} , \qquad ( 2 )$$
where B(k, l) and B′(k, l) indicate pixel values of (k, 1) of the current macro block and the decoded macroblock, respectively. λ may be obtained using Equation 3.
   λ=0.85×2^{QP/3} (3),
where QP indicates an integer ranging from 0 to 51 and is a H.264 quantization value, and Rate indicates the number of bits required for encoding of the current macroblock.

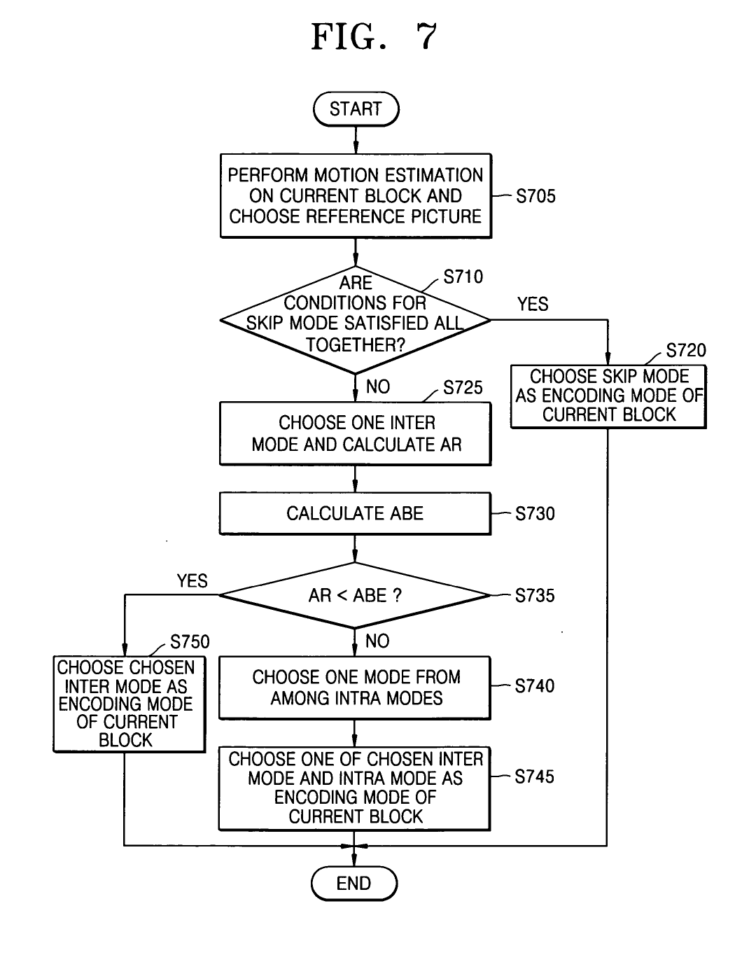

FIG. 7 is a flowchart illustrating a method of deciding an encoding mode.

Once a current block is input, it is primarily checked whether the current block is in a skip mode or not. In the skip mode, only encoding mode information of a block to be encoded is transmitted or stored. There is a high probability that a pixel value of a given block of a current block is identical to that of a corresponding block of a reference block because only the encoding mode information is transmitted or stored without a need for transmission or storing of additional encoded data such as residual signals or motion vector information. To check whether the current block is in the skip mode or not, motion estimation is performed on the current block and a reference picture is chosen, in step S705. In step S170, it is determined whether the current block satisfies all of the following four conditions:
\mathring{1} the block size used for inter prediction is 16×16, \mathring{2} the reference picture used to encode the current block is temporally closest to the current picture among reference pictures stored in the frame memory just one previous picture), \mathring{3} the motion vector is (0, 0) or the same as its PMV, and \mathring{4} the transform coefficients of the residual signals that are differences in pixel values of the current block and the reference picture are all quantized to zero.

Alternatively, all of the following three conditions must be met:
\mathring{1} the block size used for inter prediction is 8×8, \mathring{2} the reference picture and the motion vector that are used to encode the current block are the same as predicted values from the reference picture of a block that is spatially or temporally adjacent to the current block and motion vector information of the block, and \mathring{3} the transform coefficients of the residual signals that are differences in pixel values of the current block and the reference picture are all quantized to zero.

Once the above skip conditions are all satisfied, the block is determined to be in the skip mode and an encoding mode decision process is terminated without checking to see if the current block has other modes, in step S720.

If the above skip conditions are not met, inter prediction is performed in other modes inter prediction can have, an inter mode is decided from among the modes of inter prediction, and the number of bits obtained when encoding is performed in the decided inter mode is calculated, in step S725. At this time, the inter mode is chosen from among a group of some of all the possible modes, instead of from among all the possible modes. In this way, an average rate (AR) is calculated. The AR is calculated using Equation 4 and indicates a rate per pixel. Since inter prediction is already performed, a rate is already known.

$$AR = \frac{1}{384} Rate \times λ , 384 = {( 16 \times 16 )}_{Luma} + {( 8 \times 8 )}_{Chroma} \times 2 \qquad ( 4 )$$

In step S730, an average boundary error (ABE) is calculated.

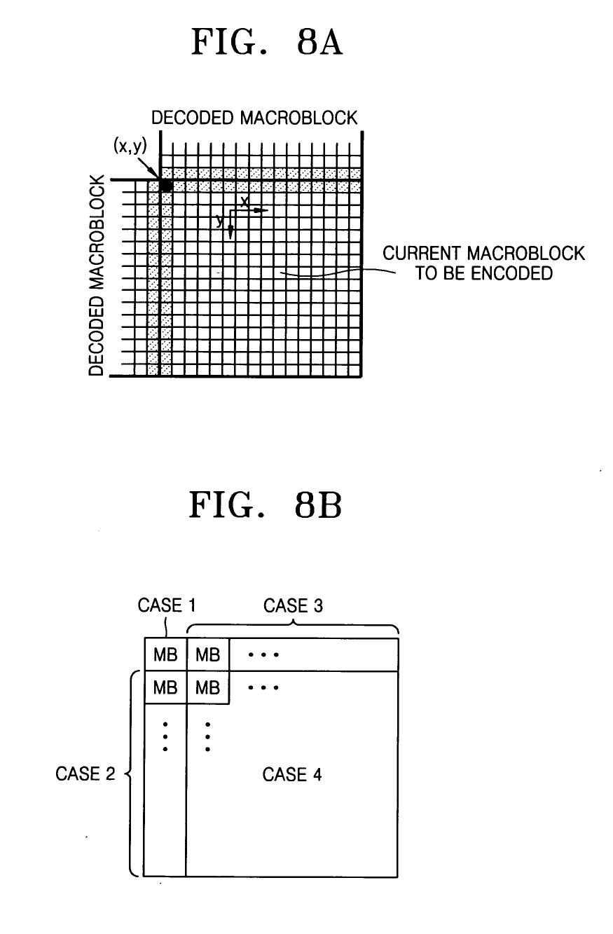

FIGS. 8A and 8B are views for explaining calculation of the ABE.

To calculate the ABE, a sum of boundary error (SBE) is calculated using Equation 5. Then, an ABE per pixel is calculated.

$$\begin{matrix}SBE = {\sum }_{i = 0}^{15} [ \vert {Y}_{Orig} ( x , y + i ) - {Y}_{Rec} ( x - 1 , y + i ) \vert + \\ \vert {Y}_{Orig} ( x + i , y ) - {Y}_{Rec} ( x + i , y - 1 ) \vert ] + \\ {\sum }_{i = 0}^{7} [ \vert {U}_{Orig} ( cx , cy + i ) - {U}_{Rec} ( cx - 1 , cy + i ) \vert + \\ \vert {U}_{Orig} ( cx + i , cy ) - {U}_{Rec} ( cx + i , cy - 1 ) \vert ] + \\ {\sum }_{i = 0}^{7} [ \vert {V}_{Orig} ( cx , cy + i ) - {V}_{Rec} ( cx - 1 , cy + i ) \vert + \\ \vert {V}_{Orig} ( cx + i , cy ) - {V}_{Rec} ( cx + i , cy - 1 ) \vert ] \\ ABE = \frac{1}{64} SBE , where 64 = {( 16 + 16 )}_{Luma} + {( 8 + 8 )}_{Chroma} \times 2 ,\end{matrix} \qquad ( 5 )$$

where Y_{Orig}, U_{Orig}, and V_{Orig} represent the pixel values of the current macroblock and Y_{Rec}, U_{Rec}, and V_{Rec} represent the pixel values of the decoded adjacent macroblock. As can be seen in FIG. 8A, (x, y) indicates pixel coordinates of the luma block and (cx, cy) indicates pixel coordinates of the chrominance block.

Referring to FIG. 8B, in case 1, there is no decoded adjacent macroblock and the ABE cannot be calculated using Equation 5. Thus, in this case, ABE is set to 0. In case 2, if there is no left adjacent block, Equation 5 is arranged as follows.

$$\begin{matrix}SBE = {\sum }_{i = 0}^{15} [ \vert {Y}_{Orig} ( x + i , y ) - {Y}_{Rec} ( x + i , y - 1 ) \vert ] + \\ {\sum }_{i = 0}^{7} [ \vert {U}_{Orig} ( cx + i , cy ) - {U}_{Rec} ( cx + i , cy - 1 ) \vert ] + \\ {\sum }_{i = 0}^{7} [ \vert {V}_{Orig} ( cx + i , cy ) - {V}_{Rec} ( cx + i , cy - 1 ) \vert ] \\ ABE = \frac{1}{32} SBE\end{matrix} \qquad ( 6 )$$

In case 3, if there is no adjacent block above the current macroblock, Equation 5 is arranged as follows.

$$\begin{matrix}SBE = {\sum }_{i = 0}^{15} [ \vert {Y}_{Orig} ( x , y + i ) - {Y}_{Rec} ( x - 1 , y + i ) \vert ] + \\ {\sum }_{i = 0}^{7} [ \vert {U}_{Orig} ( cx , cy + i ) - {U}_{Rec} ( cx - 1 , cy + i ) \vert ] + \\ {\sum }_{i = 0}^{7} [ \vert {V}_{Orig} ( cx , cy + i ) - {V}_{Rec} ( cx - 1 , cy + i ) \vert ] \\ ABE = \frac{1}{32} SBE\end{matrix} \qquad ( 7 )$$

In case 4, the ABE can be calculated using Equation 5.

In step S735, the AR and the ABE are compared. Calculations of the AR and the ABE are examples of calculations of temporal similarity and spatial similarity, respectively. If the ABE is greater than the AR, it means that the current macroblock has higher probability of being in the inter mode rather than the intra mode. Thus, in step S750, the current macroblock is determined to be in the inter mode chosen in step S725 and the process is terminated. If the ABE is not greater than the AR, one mode is chosen from among intra modes in step S740. In step S745, an encoding mode of the current macroblock is chosen from among the decided intra mode and the previously chosen inter mode.

Another example of a determination of temporal similarity besides the AR is to use differences in pixel values of the macroblock of the current picture and the reference block of the reference picture in the inter mode. The differences can be obtained by calculating the differences between respective pixel values of the current macroblock and the reference block of the reference picture, summing the absolute values of the differences or squared values of the differences, and multiplying the sum by a predetermined ratio λ.

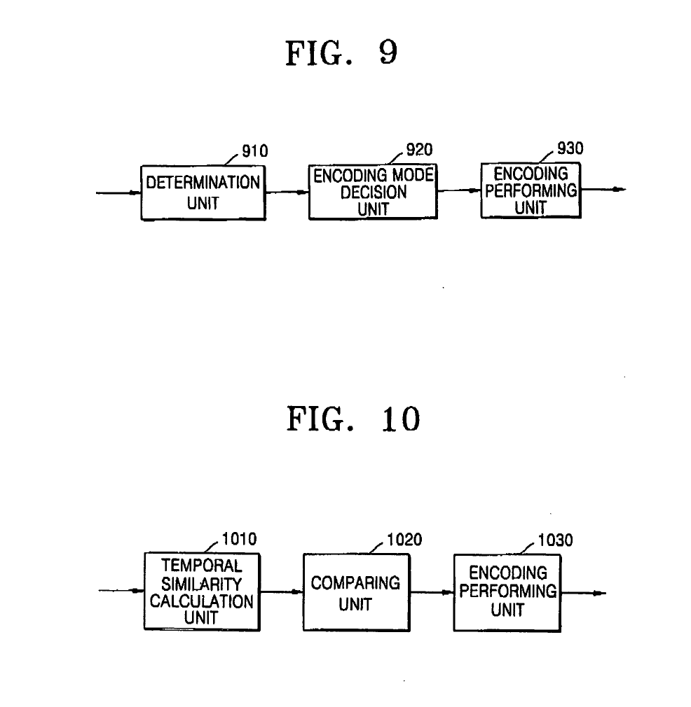

FIG. 9 is a schematic block diagram of an apparatus for video encoding according to the embodiment of the present invention.

The apparatus for video encoding includes a determination unit 910, an encoding mode decision unit 920, and an encoding performing unit 930.

The determination unit 910 determines whether a block of a predetermined size forming a video satisfies conditions for the skip mode among a plurality of encoding modes used for video encoding. The conditions for the skip mode are already described above. The encoding mode decision unit 920 decides the skip mode as the encoding mode of the block if all the conditions as described above are satisfied. If the conditions are not satisfied, the encoding mode decision unit 920 further performs inter prediction or intra prediction and selects one of various encoding modes as the encoding mode of the block.

The encoding performing unit 930 creates compressed video data according to the encoding mode chosen by the encoding mode decision unit 920.

FIG. 10 is a schematic block diagram of an apparatus for video encoding according to another embodiment of the present invention.

A temporal similarity calculation unit 1010 calculates temporal similarity of the macroblock of the current picture with the reference block of the reference picture in the inter mode.

A comparing unit 1020 determines whether to omit an encoding process in the intra mode according to the calculated temporal similarity and spatial similarity between the macroblock of the current picture and the adjacent block. Thus, one encoding mode is decided. Preferably, but not necessarily, the temporal similarity and the spatial similarity are calculated based on the AR and the ABE.

Another example of calculation of the temporal similarity is to use differences in pixel values of the macroblock of the current picture and the reference block of the reference picture in the inter mode. The differences can be obtained by calculating the differences between respective pixel values of the current macroblock and the reference block of the reference picture, summing the absolute values of the differences or squared values of the differences, and multiplying the sum by the predetermined ratio λ.

The encoding performing unit 1030 creates compressed video data according to the encoding mode decided by the comparing unit 1020.

The method for video encoding according to the present invention can be written as computer programs. Codes and code segments forming the programs can be easily construed by programmers skilled in the art to which the present invention. Also, the programs are stored in computer readable media and read and implemented by computers, thereby implementing the method for video encoding. Examples of the computer readable media include magnetic recording media, optical recording media, and carrier waves.

According to the present invention, it is possible to rapidly perform video encoding without significant degradation of display quality. In other words, the number of calculations of Rdcosts is reduced by 70% or more without greatly reducing the signal-to-noise ratio. As a result, the amount of time required for video encoding can be reduced by about 30%.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method for video encoding comprising:
(a) determining whether a predetermined block of a predetermined size forming a video satisfies predetermined conditions corresponding to a first mode of a plurality of video encoding modes; and
(b) choosing the first mode as an encoding mode of the predetermined block if the predetermined conditions are satisfied.

2. The method of claim 1, further comprising (c) creating encoded video data of the predetermined block in the first mode.

3. The method of claim 1, wherein the first mode is a skip mode in which encoding mode information of the predetermined block is only transmitted or stored.

4. The method of claim 3, wherein the first mode is a skip mode in H.264.

5. The method of claim 1, wherein the predetermined conditions comprise a block size used for inter prediction is 16×16, a reference picture is just one previous picture, a motion vector is (0, 0) or the same as a predicted motion vector, and transform coefficients of residual signals that are differences in pixel values of the predetermined block and a block of the reference picture are all converted and quantized to 0.

6. The method of claim 1, wherein the predetermined conditions comprise a block size used for motion estimation of the predetermined block is 8×8, a first reference picture and a first motion vector are the same as predicted values from a second reference picture of an adjacent block that is spatially or temporally adjacent to the predetermined block and a second motion vector of the adjacent block, and differences in pixel values of the predetermined block and the adjacent block of the reference picture are all converted and quantized to 0.

7. A method for video encoding comprising:
(a) calculating temporal similarity of a predetermined block of a predetermined size forming a video with a reference block of a reference picture in an inter mode; and
(b) determining whether to omit an encoding process in an intra mode according to the calculated temporal similarity and spatial similarity between a block of the current picture and an adjacent block.

8. The method of claim 7, wherein the temporal similarity is determined using a number of bits required for encoding the predetermined block and the spatial similarity is determined by differences in pixel values between the block of the current picture to be encoded and the adjacent block thereof.

9. The method of claim 7, wherein the temporal similarity is determined by differences in pixel values between the predetermined block and the reference block of the reference picture and the spatial similarity is determined by differences in pixel values between the block of the current picture to be encoded and the adjacent block thereof.

10. The method of claim 8, wherein in the block of the current picture to be encoded, the spatial similarity is determined by calculating the differences in the pixel values of pixels present at boundaries between the block of the current picture to be encoded and other adjacent decoded blocks for luminance and chrominance.

11. The method of claim 8, wherein the temporal similarity is determined by a number of bits required for encoding a difference between the predetermined block of the current picture and the reference block, a number of bits required for encoding a motion vector, and a number of bits required for encoding reference picture information.

12. An apparatus for video encoding comprising:
a determination unit, which determines whether a predetermined block of a predetermined size forming a video satisfies predetermined conditions corresponding to a first mode of a plurality of video encoding modes; and
an encoding mode decision unit, which chooses the first mode as an encoding mode of the predetermined block if the predetermined conditions are satisfied.

13. The apparatus of claim 12, further comprising an encoding performing unit which creates compressed video data in the first mode.

14. The apparatus of claim 12, wherein the first mode is a skip mode in H.264.

15. The apparatus of claim 12, wherein the predetermined conditions comprise a block size used for inter prediction is 16×16, a reference picture is just one previous picture, a motion vector is (0, 0) or the same as a predicted motion vector, and transform coefficients of residual signals that are differences in pixel values of the predetermined block and a block of the reference picture are all quantized to 0.

16. The apparatus of claim 12, wherein the predetermined conditions comprise a block size used for motion estimation of the predetermined block is 8×8, a first reference picture and a first motion vector are the same as predicted values from a second reference picture of a block that is spatially or temporally adjacent to the predetermined block and a second motion vector of the adjacent block, and differences in pixel values of the predetermined block and the adjacent block of the reference picture are all converted and quantized to 0.

17. An apparatus for video encoding comprising:
a temporal similarity calculation unit, which calculates temporal similarity of a predetermined block of a predetermined size forming a video and a reference block of a reference picture in an inter mode; and
a comparing unit, which determines whether to omit an encoding process in an intra mode according to a difference between the calculated temporal similarity and spatial similarity between the predetermined block and a block adjacent to the current picture.

18. The apparatus of claim 17, further comprising an encoding performing unit which creates compressed video data in a decided encoding mode.

19. The apparatus of claim 17, wherein the temporal similarity is determined by a number of bits required for encoding the predetermined block and the spatial similarity is determined by differences in pixel values between the predetermined block to be encoded and the block adjacent thereof.

20. The apparatus of claim 17, wherein the temporal similarity is determined by differences in pixel values between the predetermined block and the reference block of the reference picture and the spatial similarity is determined by differences in pixel values between the predetermined block to be encoded and the block adjacent thereof.

21. The apparatus of claim 19, wherein in the predetermined block to be encoded, the spatial similarity is determined by calculating the differences in pixel values of pixels present at boundaries between the predetermined block to be encoded and other adjacent decoded blocks for luminance and chrominance.

22. The apparatus of claim 19, wherein the temporal similarity is determined by a number of bits required for encoding a difference between the predetermined block of the current picture and the reference block, a number of bits required for encoding a motion vector, and a number of bits required for encoding reference picture information.

23. A computer readable medium having embodied thereon programs for implementing a method for video encoding comprising:
(a) determining whether a predetermined block of a predetermined size forming a video satisfies predetermined conditions corresponding to a first mode of a plurality of video encoding modes; and
(b) choosing the first mode as an encoding mode of the predetermined block if the predetermined conditions are satisfied.
